(19) United States
(12) Patent Application Publication
(10) Pub. No.: US 2018/0221695 A1
(43) Pub. Date: Aug. 9, 2018

(54) SILENT FIRE SUPPRESSION SYSTEM

(71) Applicant: Fike Corporation, Blue Springs, MO (US)

(72) Inventors: Bon Shaw, Blue Springs, MO (US); Bradford T. Stilwell, Blue Springs, MO (US)

(21) Appl. No.: 15/891,476

(22) Filed: Feb. 8, 2018

Related U.S. Application Data
(60) Provisional application No. 62/456,882, filed on Feb. 9, 2017.

(51) Int. Cl. A62C 35/02; A62C 35/13; A62C 37/36; A62C 37/40

(52) U.S. Cl. CPC A62C 35/023; A62C 37/40; A62C 37/04; A62C 35/13

(57) ABSTRACT

A clean agent fire suppression system (10a, 10b) is provided that avoids mixing of the agent and propellant. A compartmentalized storage vessel (12) having two compartments (20, 22) separated by a membrane (24) maintains a propellant supplied by a propellant source (34) isolated from the fire suppressing agent. The fire suppressing agent may be stored at room temperature and/or under atmospheric pressure and, upon actuation of the system, delivered to the nozzles (16) installed within the protected space (18) at much lower pressures. This reduction in delivery pressure decreases noise generation as the suppressing agent is released into the protected space.

### RELATED APPLICATION

The present application claims the priority benefit of U.S. Provisional Patent Application Ser. No. 62/456,882, filed Feb. 9, 2017, which is incorporated by reference in its entirety herein.

### BACKGROUND OF THE INVENTION

### Field of the Invention

The present invention is generally directed toward a clean agent fire suppression system that is capable of delivering fire suppressing agent to a protected area at a reduced pressure as compared to conventional clean agent fire suppression systems. The reduction in delivery pressure decreases noise generation as the suppressant is released into the protected area. In addition, the present invention avoids the use of a propellant that is dispensed into the protected area along with the suppressing agent, which reduces the volume of fluid that any associated piping system must accommodate, and eliminates unwanted side-effects associated with propellant release into the protected area.

### Description of the Prior Art

Clean agent fire suppression delivery systems typically comprise a liquid agent that is stored in a pressurized cylinder. The liquid agents used in fire suppression applications generally have insufficient vapor pressure to dispense the agent at the desired rate, therefore, a gaseous propellant is employed to assist with the dispensing rate. Most clean agent fire suppression systems store the propellant in the same container with the clean agent, while some systems store the agent in a separate pressurized cylinder that is added to the clean agent cylinder at the time of release.

The propellant, typically nitrogen, dissolves into the clean agent and is dispensed therewith upon deployment of the suppressant into the protected space. The combination of clean agent and propellant flowing in the discharge piping increases the total mass flow within a given pipe size. This results in generally larger piping being required as compared to flowing of only the clean agent in a liquid state. In addition, the combination of gases, again typically a suppressant gas along with nitrogen, results in a two-phase flow the characteristics of which are difficult to predict thereby requiring much experimentation to determine the flow characteristics through various pipes and fittings. In order to meet requirements mandated by NFPA, UL, and FM, the complete discharge of clean agent in response to a fire must be accomplished within a maximum of 10 seconds. Exceeding a 10 second discharge time results in insufficient fire suppression outcomes and is not acceptable. Since there is presently no fire suppression agent with sufficient vapor pressure to dispense itself as rapidly as needed, a propellant is typically added to the clean agent in the bottle, and as a result is mixed with and dispensed along with the clean agent. The typical pressure within such a clean agent cylinder is approximately 360 psi or greater.

The storage container size and strength are affected by the need to hold the volume of clean agent required along with the additional propellant. The 360 psi storage pressure necessitates increased cylinder wall thickness, which also increases the weight and cost of the container. In addition, the high-volume, high-pressure containers result in transportation safety concerns necessitating overdesign requirements and restrictions imposed by regulatory authorities.

The discharge of this high-pressure gas in such a short time period results in a particularly violent and noisy event due to the sudden onset of the liquefied clean agent flow. This initially causes a water hammer-like noise. Additionally, the two-phase gas/liquid flow in the piping, and the high-pressure release of the clean agent and propellant gases at the dispensing nozzles within the protected space is quite noisy. This noise can create fear and panic by the room occupants and has been reported to cause damage to computer storage devices and/or reduced data transfer rates due to induced hardware errors.

Due to the high-pressure gas being discharged, adiabatic cooling of the suppressant gas occurs. The sudden discharge of the combination of clean agent gas and the propellant, or either gas alone, results in a depressurization of approximately 360 psi, or greater, to atmospheric pressure. It is the sudden depressurization of the gas, conditioned to room temperature prior to discharge, that causes adiabatic cooling. This, now cold, gas has been measured to be approximately 0 degrees Fahrenheit when dispensed from a gas cylinder pressurized to 360 psi and stored at room temperature. The cold gas often cools the air in the protected space to near the dew point causing a vision-obscuring fog that hampers locating room walkways and exits.

The adiabatic cooling created by discharge of the suppressant gas also creates a concern with room pressurization within the protected area. The cooling created by the discharge of the suppressant gas can cause, in certain instances, an initial decrease in room pressure followed by a rise in room pressure due to the introduction of the volume of suppressant gas (and propellant). In certain applications, the room comprising the protected area is constructed to minimize leakage of air from the outside in. Therefore, equalization of pressure between the room's interior and the surrounding environment may progress relatively slowly. This phenomenon can place great strain on the structural integrity of the room, quite possibly resulting in structural failure of the room itself.

The dispensing of clean agents is typically accomplished with the use of valves. Some valves are of the reusable kind and are opened with electrical signals. Some valves are of the rupture disc design and are opened using a striking mechanism or explosive device to damage the rupture disc causing it to open. Valves of either kind rely upon relatively complicated engineering. They often involve a multitude of electrical solenoid coils, moving parts, springs, small parts and orifices that must work perfectly together to be reliable.

The orientation of storage cylinders of clean agents is determined in advance and is limited in use to its anticipated placement. Typical cylinder placement designs include upright, inverted, or on its side. In any case, the pre-engineered design must be observed for proper dispensing operation.

Some clean agent dispensing systems maintain the high-pressure propellant separate from the clean agent storage tank. These systems mix the propellant and clean agent gases together upon system discharge. This type of system design relies upon sufficient mass flow from the external propellant tank to the clean agent tank for proper system operation. As with pre-mixed systems, both the clean agent and the propellant are discharged within the protected space.

There is a need in the art for a clean agent dispensing system that overcomes the aforementioned problems and limitations. In particular, there is a need to reduce the weight and cost associated with the use of thick-walled high pressure storage containers, to avoid the need to transport large quantities of super-pressurized gases, to avoid the mixing of clean agent and propellant and thereby reduce the mass of two-phase material required to be carried by the piping network and released within the protected space, and to avoid difficulties in predicting the behavior of two-phase flow within the piping network. There is a need to avoid creation of vision-obscuring fog due to the creation of adiabatic chilling of the suppression gas resulting in the temperature within the protected space nearing the dew point, and to reduce the high decibel noise associated with high-pressure, two-phase flow discharge of clean agent and possible noise damage of equipment and panic by those within the protected space. There is a need to avoid the use of complicated electromechanical, pneumatic, or explosive valve sealing the clean agent tank, to eliminate the requirement for specific storage cylinder orientation for a particular installation, to avoid the need for gravity to stabilize and fix the location of liquid and gaseous components within the cylinder, and to eliminate a failure mode when an external propellant tank flows slower than is required for timely clean agent discharge.

### SUMMARY OF THE INVENTION

Embodiments of the present invention are directed toward overcoming one or more of the above problems by providing a fire suppression system comprising a storage vessel comprising a fire suppressing material compartment and an accumulator compartment, the compartments being separated from each other by a membrane. The fire suppressing material compartment contains a liquid fire suppressing material, and the accumulator compartment is configured to contain a volume of a propellant supplied thereto by a propellant source that is coupled with the storage vessel. The system also comprises at least one nozzle located within a protected space, and that is operably coupled with the storage vessel via a suppressant delivery conduit. Upon detection by the system of a condition indicative of a fire within the protected space, the liquid fire suppressing material is discharged from the storage vessel, through the at least one nozzle, and into the protected space under the force exerted by the propellant upon the membrane.

In particular embodiments, the system further comprises at least one sensor operably coupled with a control unit and operable to detect conditions indicative of a fire within a protected space. The control unit is configured to initiate a flow of propellant from the propellant source into the accumulator compartment upon detection by the at least one sensor of a condition indicative of a fire within the protected space. The propellant within the accumulator compartment, upon reaching a predetermined threshold pressure, provides a motive force for transmission of the liquid fire suppressing material through the suppressant delivery conduit and out of the at least one nozzle located within the protected space.

According to another embodiment of the present invention, there is provided a method of suppressing a fire within a protected space at least one nozzle operable to discharge a fire suppressant material into the protected space. The method comprises detecting a condition indicative of a fire within the protected space, and then initiating a flow of the liquid fire suppressing material contained within a fire suppressing material compartment of a storage vessel out of the fire suppressing material compartment under force exerted upon a membrane by a propellant contained within an accumulator compartment of the storage vessel. The fire suppressing material is discharged from the at least one nozzle into the protected space.

In particular embodiments, the method further comprises using at least one sensor located within the protected space to detect a condition indicative of a fire within the protected space and causing a signal to be sent to a control unit that is operably connected to a propellant source. A flow of a propellant from the propellant source is initiated to the accumulator compartment, which is separated from the fire suppressing material compartment by a membrane. The accumulator compartment is pressurized to a predetermined threshold pressure. A flow of the liquid fire suppressing material out of the fire suppressing material compartment and through a suppressant delivery conduit to the at least one nozzle is initiated. The fire suppressing material is then discharged from the at least one nozzle into the protected space.

### BRIEF DESCRIPTION OF THE DRAWINGS

FIG. 1 is a schematic depiction of exemplary fire suppression systems according to the present invention;

FIG. 2 is a partially-sectioned view of a clean agent storage tank that may be used with certain embodiments of the present invention in which the clean agent and propellant are maintained separately from each other;

FIG. 3 is a cross-sectional view of a clean agent storage tank in which the propellant compartment is being filled with pressurized gas;

FIG. 4 is a cross-sectional view of a clean agent storage tank in which the propellant pressure has been sufficiently elevated so as to open a valve permitting clean agent to be released under pressure from the clean agent compartment;

FIG. 5 illustrates a “dumb” fire suppression system in which release of fire suppressing material is controlled by a fire sprinkler head without need for electronic monitoring equipment; and

FIG. 6 is a close-up view of an exemplary sprinkler head that may be used with embodiments of the present invention to control the release of fire suppressing material.

### DETAILED DESCRIPTION OF THE PREFERRED EMBODIMENT

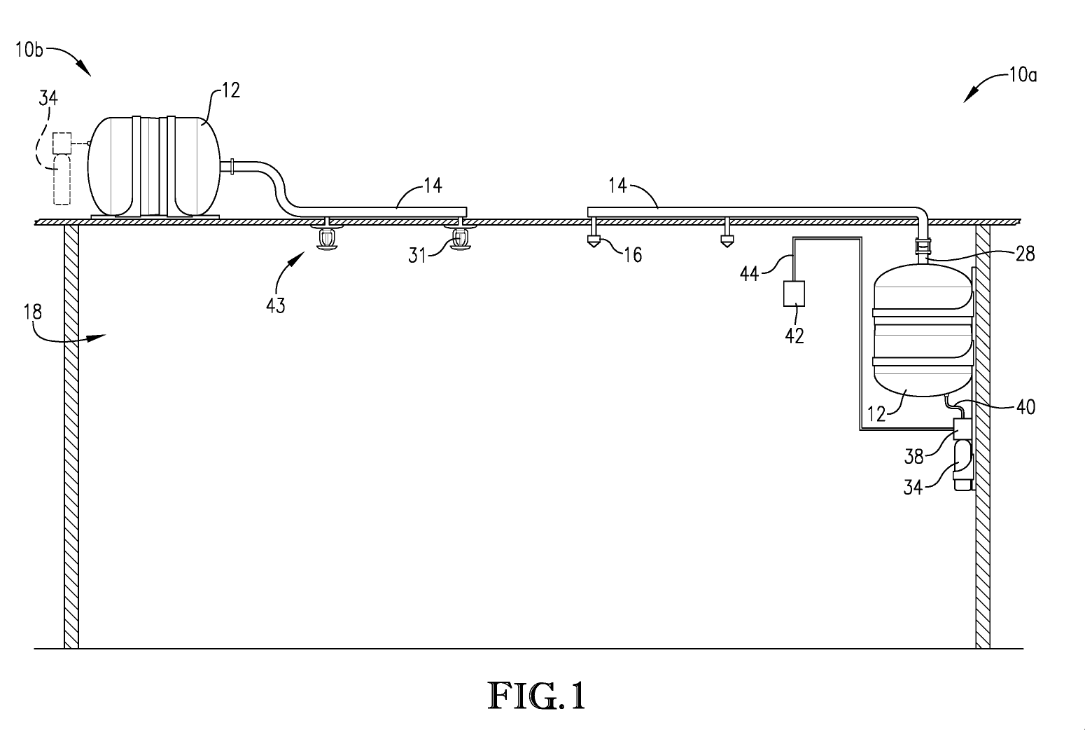

Turning to FIG. 1, examples of a “smart” fire suppression system 10a and a “dumb” fire suppression system 10b in accordance with embodiments of the present invention are illustrated. Systems 10a and 10b generally comprise a fire suppressant storage vessel 12 operably coupled with a delivery conduit 14 having one or more nozzles 16 installed within a protected space 18. System 10a, however, comprises an electronic sensor 42, which is responsible for triggering a release of liquid fire suppressing material from storage vessel 12. System 10b relies upon a mechanical actuator 43 for detecting a condition indicative of a fire within the protected space 18 and initiating a release of the liquid fire suppressing material from storage vessel 12. As illustrated in FIG. 1, storage vessel 12 may be mounted on a wall within the protected space 18 or in the ceiling, thereby greatly shortening the length of conduit that the fire suppressing material must traverse during deployment. Of course, it is within the scope of the present invention for storage vessel 12 to be located in a more remote location relative to the protected space, such as in an adjacent room or closet.

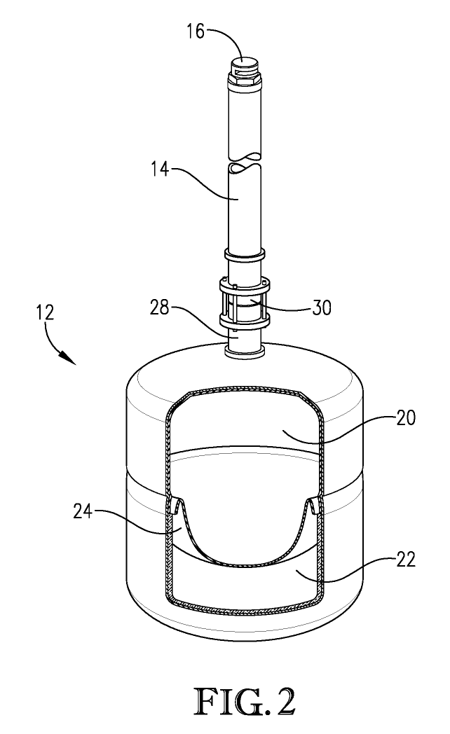

As can be seen in FIG. 2, storage vessel 12 comprises two storage compartments 20, 22 that are maintained separately by a membrane 24. In certain embodiments, membrane 24 comprises an elastomeric diaphragm the outer circumference of which is secured to the vessel sidewall, such as illustrated in the Figures. Alternatively, membrane 24 can be in the form of a bladder having an open end that is secured, for example, to the vessel bottom wall. An exemplary vessel that may be used with the present invention is the Watts PLT-12 4.5 gallon potable water expansion tank manufactured by Watts Water Quality Products Company. However, the vessel can be manufactured to any size and specification to meet clean agent suppression system requirements for a particular application.

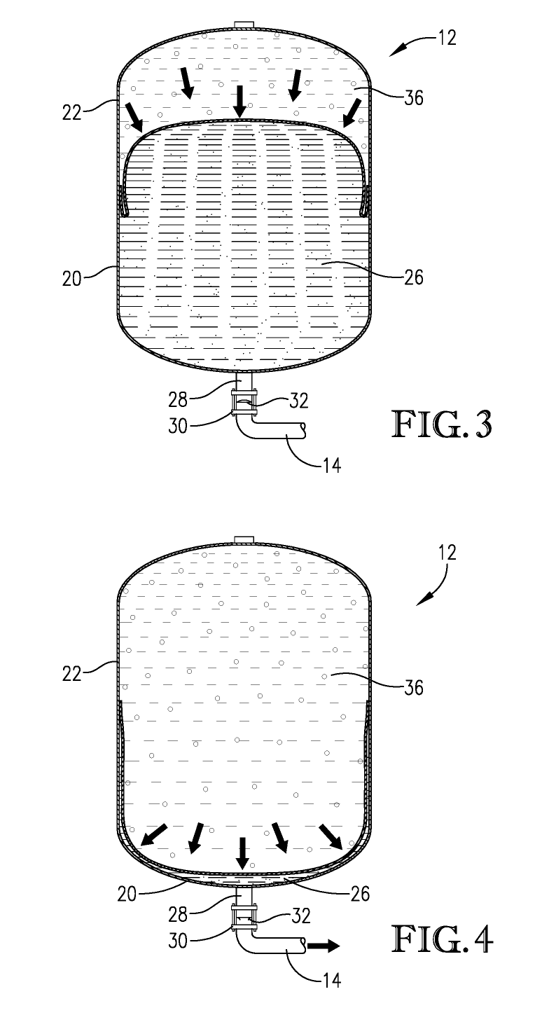

In certain embodiments, compartment 20 contains a clean fire suppressing agent 26 (see, FIG. 3). As referred to herein, clean fire suppressing agents generally comprise electrically nonconductive, volatile or gaseous fire extinguishants that do not leave a residue upon evaporation. Clean fire suppressing agents can extinguish a fire through one or more modes: reduction of heat, reduction or isolation of oxygen, and inhibiting the chain reaction of the foregoing components. Clean fire suppressing agents are generally non-ozone depleting and, unlike water, do not tend to cause damage to materials they come into contact with, such as electronics and irreplaceable items including works of art and important documents. Exemplary clean fire suppressing agents include fluoroketones such as 1,1,1,2,2,4,5,5,5-nonafluoro-4-(trifluoromethyl)-3-pentanone and the structural formula CF₃CF₂C(═O)CF(CF₃)₂ commercially known as NOVEC 1230 supplied by 3M. Other clean fire suppressing agents include 1,1,1,2,3,3,3-Heptafluoropropane (FM-200 supplied by Chemours), and pentafluoroethane (HFC-125 or FE-25 supplied by Chemours). However, in preferred embodiments, the clean fire suppressing agent has a boiling point of below 50° C., and generally presents as a liquid at room temperature and standard atmospheric pressure with low vapor pressure (e.g., less than 6 psig).

The outlet 28 of storage vessel 12 communicates with delivery conduit 14 thereby providing a pathway for the fire suppressing agent to be delivered to the protected space 18. However, in the embodiment of system 10a, in order to retain the fire suppressing material within storage compartment 20 until it is desired to release the suppressing agent, a valve 30 normally blocks communication between outlet 28 and delivery conduit 14. In certain embodiments, valve 30 comprises a rupture disc 32 configured to burst at or near a predetermined pressure threshold. Single-use rupture discs provide highly reliable passive valve opening. The rupture disc may be of the forward or reverse-acting type and may form a single or multiple petals upon opening. Alternatively, the valve 30 may comprise any other type of pressure relief valve capable of opening at or near a predetermined pressure threshold. However, in certain embodiments, the use of more complex valves requiring electromechanical, pneumatic, or explosive is avoided.

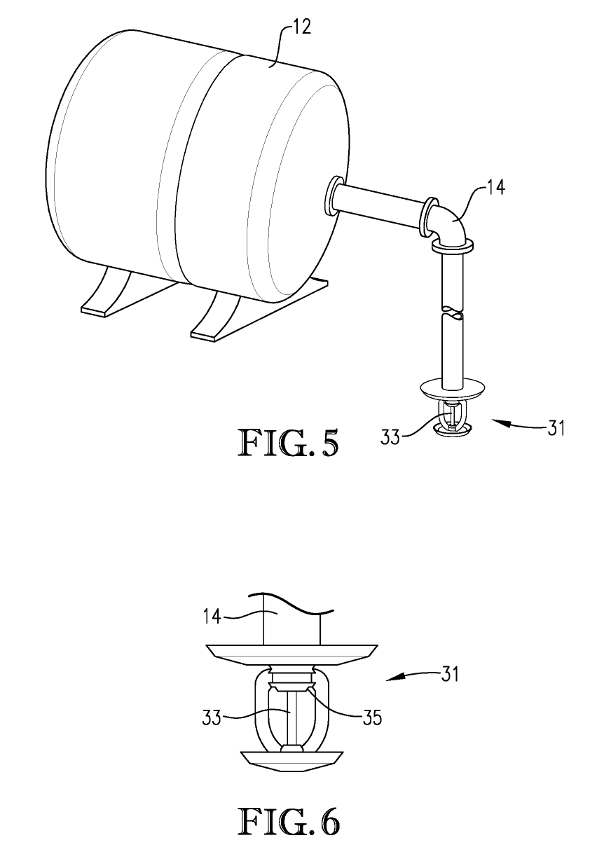

In the embodiment of system 10b, the function of valve 30 is performed by a passive actuator, such as a fire sprinkler head 31 that comprises nozzle 16. As shown in FIGS. 5 and 6, in certain embodiments, fire sprinkler head 31 comprises a heat-sensitive glass bulb 33 that applies pressure to a plug 35 which prevents liquid fire suppressing material from flowing into the protected space 18. The glass bulb 33 breaks as a result of the thermal expansion of a liquid inside the bulb, which would result from a rise in temperature attributable to the presence of a fire within the protected space 18. Upon breakage of the glass bulb 33, plug 35 becomes dislodged, and liquid fire suppressing material is released from head 31.

Accumulator compartment 22 is configured to contain a propellant under sufficient pressure so as to be able to deliver the fire suppressing material to the protected space and to provide a sufficient pressure differential so that the fire suppressant may vaporize upon introduction into the protected space. Accumulator compartment 22 is connected to a source of propellant 34 that is capable of supplying a sufficient amount of propellant 36 thereto in order to accomplish the aforementioned delivery and vaporization. The propellant may be any suitable gas or liquid including, but not limited to, air, nitrogen, and carbon dioxide. Since the propellant does not combine with the suppressant gas or discharge into the room, its composition can be optimized as a propellant with few other concerns.

The propellant source 34 may be a cylinder of compressed gas or a device that produces gas on demand such as a gas generator similar to one found in an automotive airbag inflation device. In the embodiment of system 10a, an actuating mechanism or control unit 38 is used to allow the creation of and/or flow of propellant into the gas-side accumulator compartment 22 of the storage vessel 12 via supply line 40. The actuating mechanism 38 varies depending upon the technology employed for the propellant. If a sealed gas cylinder is used as the propellant source, the actuator may be a piercing needle. The piercing needle can be activated by many means such as an electrical solenoid, or external pneumatic pressure. If a valved gas cylinder is used, the actuating means may be a solenoid valve, a motor, pneumatic pressure, or any other means capable of operating the valve on this type of gas cylinder. If a gas generator is used, the actuator may be an electrical signal generator that initiates a chemical reaction that produces a gas volume under pressure. However, it is within the scope of the present invention for any external source of pressurized gas or liquid to be employed so long as it is capable of pressurizing the storage tank 12 to a sufficient pressure to open valve 30 and release the fire suppressing agent.

In the embodiment of system 10b, the accumulator compartment 22 may be pre-charged with propellant so that upon activation of the passive actuator (e.g., fire sprinkler head 31), no further transfer of propellant from the propellant source is required to deliver the liquid fire suppressing material to the protected space 18.

One or more sensors 42 may be installed within protected space 18 that are operable to detect conditions that may be indicative of a fire. For example, sensor 42 may be a heat sensor or a smoke detector. Sensor 42 is operably connected with control unit 38 via line 44 and functional to deliver a signal thereto which causes the control unit to actuate release of propellant from the source 34. In certain embodiments, system 10a or 10b may be provided with a manual release, such as a pull station, whereby sensor 42 may be bypassed and the flow of fire suppressing agent begun as desired by an operator. In alternate embodiments of system 10a, the sensor may be replaced with a passive actuator, similar to that used with fire sprinkler head 31, but instead of directly initiating a flow of the fire suppressing material, the passive actuator initiates a flow of propellant from the propellant source into the accumulator compartment 22. Therefore, in this embodiment, system 10a also functions as a “dumb” system that does not require electronic control circuitry for operation.

In operation, the liquid-side of storage container 12, i.e., compartment 20, is filled with sufficient fire suppressing agent 26 suitable for the volume of the protected space 18. In certain embodiments, agent 26 is stored at room temperature (e.g., approximately 20-25° C.). The gas side of storage container 12, i.e., accumulator compartment 22, can be kept at vacuum, or preferably, atmospheric pressure until control unit 38 initiates release of gas from propellant source 34. Alternatively, for standby purposes, the gas side of storage vessel 12 may be maintained at any pressure less than the predetermined pressure threshold at which valve 30 will open in the case of system 10a. This permits more rapid response times upon detection of a condition indicative of a fire by sensor 42. In the case of system 10b, accumulator compartment 22 can be maintained at any desired pressure sufficient for delivering the fire suppressing material upon activation of the passive actuator.

As noted above, the fire suppressing agent used in systems 10a and 10b may be any clean agent suitable for a particular application. However, selection of the appropriate agent may affect certain other design parameters such as the strength of the storage vessel 12, strength of the rupture disc 32, and pressure on the gas side of the storage vessel. In certain embodiments, it is preferable to select a clean agent that has a low vapor pressure at room temperature and relatively low heat of vaporization. These characteristics facilitate a reduction of storage vessel mass and propellant gas pressure required for optimal performance.

In the embodiment of system 10a, upon detection of a condition indicative of a fire by sensor 42, control unit 38 effects a release of propellant, preferably carbon dioxide in certain embodiments, from source 34. The propellant flows toward storage vessel 12 via supply line 40 and into accumulator compartment 22. As shown in FIG. 3, the inflowing gas 36 exerts a force onto membrane 24 thereby pressurizing the liquid fire suppressing agent 26 contained within compartment 20. The valve 30 remains closed until the pressure within compartment 20 reaches the predetermined pressure threshold resulting in the opening of valve 30, as depicted in FIG. 4. In certain embodiments, the predetermined pressure threshold is at least 80 psig, at least 125 psig, or at least 150 psig. In other embodiments, the source 34 is operable to pressurize compartment 20 to a pressure of from about 80 to about 250 psig, from about 100 to about 200 psig, or from about 120 to about 180 psig. In the embodiment of system 10b, the accumulator compartment 22 may be pre-charged with propellant from source 34 within these same pressure ranges.

Upon opening of valve 30 or upon activation of the passive actuator, liquid fire suppressing agent 26 flows out of compartment 20 and into conduit 14 and toward nozzles 16. The flow of agent through conduit 14 occurs substantially as a single phase due to the lack of an intermixed propellant. Accordingly, this aspect permits conduit 14 to be designed using smaller diameter pipe as compared with systems in which there is two-phase flow of suppressing agent. Also, a single-phase flow makes it much easier to predict the behavior of the flow of fire suppressing agent in the conduit. The pressurized agent 26 experiences a rapid drop in pressure as it flows through and out of nozzles 16 and is at least partially, and preferably fully, vaporized. However, no propellant is expelled from vessel 12 and into conduit 14 during this process. Accordingly, no propellant is released into protected space 18. In certain embodiments, the pressure drop across the nozzle is at least 35 psig, at least 60 psig, or at least 70 psig, and/or less than 150 psig, less than 125 psig, or less than 100 psig. Because the pressure drop across the nozzle can be reduced, the adiabatic cooling effect of the release of the fire suppressing agent can also be reduced. This advantageously prevents or minimizes the creation of vision-obscuring fog through rapid chilling of the moisture contained in the air of the protected space, thus enabling easy and safe movement through the space and easy identification of exits.

In addition, because the adiabatic cooling effect within the protected space has been reduced and no propellant enters the protected space, room pressurization concerns are diminished. In certain embodiments of the present invention, the introduction of fire suppressing agent induces a change in pressure within the protected space of less than ±500 Pa, or less than ±300 Pa, or less than ±200 Pa from the pressure within the space prior to agent discharge (or the ambient, assuming the pressure within the space was in equilibrium with the ambient environment). Because certain embodiments of the present invention reduce room pressurization concerns, the incorporation of external venting apparatus in the design of the protected space can be avoided.

An advantage of certain embodiments of the present invention is that the generation of noise as the suppressing agent is released is substantially reduced due to the lower pressures employed and lack of gaseous discharge as compared with conventional clean agent fire suppression systems. In particular embodiments, the fire suppression system 10 is configured to emit the fire suppressing agent from the at least one nozzle 16 at a noise level of less than 100 dB, less than 90 dB, or less than 80 dB. The reduction in noise generation is particularly beneficial when the protected space makes up part of a data center in that the risk of damaging computer server hard drives through the deployment of the fire suppressing agent is reduced. In a broader context, the reduction in noise generation can eliminate panic of occupants of the protected space, enhance communication within the protected space, and promote the conduct of much safer post-deployment activities, such as space evacuation.

Care should be taken when filling compartment 20 with the fire suppressing agent. In certain embodiments, particularly when NOVEC 1230 is selected at the fire suppressing agent, compartment 20 cannot be overfilled as the agent's volume is expected to fluctuate as a function of storage temperature. Moreover, the higher the fill density (volume of fire suppressing agent as a percentage of storage vessel volume) of storage vessel 12, the smaller the gas volume available within compartment 22 for filling with propellant. It is understood that a balance should be struck to ensure adequate propellant volume to completely empty compartment 20 of fire suppressing agent. In addition, in certain embodiments, the final propellant pressure within compartment 22 should be approximately 35 psig in order to ensure vaporization of the fire suppressing agent as it is introduced into protected space 18 via nozzles 16. The gas side accumulator compartment 22 is sized so that complete discharge of fire suppressing agent is not dependent upon the continued supply of propellant from source 34. This particular design element provides a fail-safe against insufficient mass flow from the source of propellant.

Based on the above, in certain embodiments, especially those in which NOVEC 1230 is selected as the fire suppressing agent, a fill density of from about 65% to about 90%, or from about 70% to about 85%, or from about 75% to about 83% is appropriate. Also, the valve 30 may have a rated opening pressure of from about 80 to about 175 psi, from about 100 to about 150 psi, or from about 120 to about 135 psi.

We claim:

1. A fire suppression system comprising:
a storage vessel comprising a fire suppressing material compartment and an accumulator compartment, the compartments being separated by a membrane, wherein a liquid fire suppressing material is contained within the fire suppressing material compartment;
a propellant source operably coupled with the storage vessel and configured to introduce a propellant into the accumulator compartment; and
at least one nozzle located within a protected space and operably coupled with the storage vessel via a suppressant delivery conduit,
wherein upon detection by the system of a condition indicative of a fire within the protected space, the liquid fire suppressing material is discharged from the storage vessel, through the at least one nozzle, and into the protected space under the force exerted by the propellant upon the membrane.

2. The fire suppression system according to claim 1, wherein the propellant source is operable to pressurize the accumulator compartment to a pressure of at least 75 psig.

3. The fire suppression system according to claim 2, wherein the propellant source is operable to pressurize the accumulator compartment to a pressure of from about 80 to about 250 psig.

4. The fire suppression system according to claim 1, wherein the storage vessel comprises a bladder tank.

5. The fire suppression system according to claim 1, wherein the membrane comprises an elastomeric diaphragm.

6. The fire suppression system according to claim 1, wherein the at least one nozzle is configured to vaporize at least a portion of the fire suppressing material upon discharge of the fire suppressing material into the protected space.

7. The fire suppression system according to claim 1, wherein the system comprises a least one sensor that is operably coupled with a control unit and is operable to detect conditions indicative of a fire within the protected space, wherein the control unit is configured to initiate a flow of propellant from the propellant source into the accumulator compartment upon detection by the at least one sensor of a condition indicative of a fire within the protected space.

8. The fire suppression system according to claim 7, wherein the at least one sensor comprises a heat or smoke detector.

9. The fire suppression system according to claim 7, wherein the propellant within the accumulator compartment, upon reaching a predetermined threshold pressure, effects a release of the liquid fire suppressing material from the fire suppressing material compartment and into the protected space.

10. The fire suppression system according to claim 9, wherein the fire suppression system further comprises a valve disposed downstream of the storage vessel that is configured normally to block the flow of fire suppressing material between the storage tank and the at least one nozzle until the predetermined threshold pressure is reached and the valve opens.

11. The fire suppression system according to claim 10, wherein the valve comprises a rupture disc configured to burst at or near the predetermined threshold.

12. The fire suppression system according to claim 1, wherein the at least one nozzle comprises a sprinkler head that includes a plug that normally retains the liquid fire suppressing material within the fire suppressing material compartment until a conditioning within the protected space that is indicative of a fire causes the plug to fail thereby initiating a flow of the liquid fire suppressing material into the protected space.

13. The fire suppression system according to claim 1, wherein the fire suppressing material is a clean agent.

14. The fire suppression system according to claim 1, wherein the fire suppressing material comprises a fluorinated ketone.

15. The fire suppression system according to claim 1, wherein the fire suppression system further comprises a manual release configured to initiate the flow of propellant from the propellant source into the accumulator compartment.

16. The fire suppression system according to claim 1, wherein the fire suppression system is configured to emit the fire suppressing agent from the at least one nozzle at a noise level of less than 100 dB.

17. The fire suppression system according to claim 1, wherein the accumulator compartment is supplied with a volume of the propellant from the propellant source prior to detection by the system of the condition indicative of a fire within the protected space.

18. A method of suppressing a fire within a protected space having located therein at least one nozzle operable to discharge a liquid fire suppressing material into the protected space, the method comprising the steps of:
detecting a condition indicative of a fire within the protected space;
initiating a flow of the liquid fire suppressing material contained within a fire suppressing material compartment of a storage vessel out of the fire suppressing material compartment under force exerted upon a membrane by a propellant contained within an accumulator compartment of the storage vessel; and
discharging the fire suppressing material from the at least one nozzle into the protected space.

19. The method according to claim 18, wherein at least one sensor operable to detect a condition indicative of a fire is installed within the protected space, wherein the detecting step causing a signal to be sent from the at least one sensor to a control unit that is operably connected to a propellant source.

20. The method according to claim 19, the method further comprising initiating a flow of the propellant from the propellant source and into the accumulator compartment of the storage vessel thereby pressurizing the accumulator compartment to a predetermined threshold pressure.

21. The method according to claim 20, wherein the step of pressurizing the accumulator compartment comprises pressurizing the accumulator compartment to a pressure of at least 75 psig.

22. The method according to claim 20, wherein the step of initiating a flow of the liquid fire suppressing material out of the fire suppressing material compartment comprises, upon reaching the predetermined threshold pressure, opening a valve disposed downstream of the storage vessel that is configured normally to block the flow of fire suppressing material between the storage tank at the at least one nozzle.

23. The method according to claim 22, wherein the valve comprises a rupture disc configured to burst at or near the predetermined pressure threshold, and wherein the step of initiating a flow of the liquid fire suppressing material out of the fire suppressing material compartment comprises bursting the rupture disc.

24. The method according to claim 18, wherein the detecting step comprises detecting the condition of a fire using a heat or smoke detector.

25. The method according to claim 18, wherein the at least one nozzle comprises a sprinkler head that includes a plug that normally retains the liquid fire suppressing material within the fire suppressing material compartment, and wherein the detecting step comprises causing the plug to fail thereby initiating a flow of the liquid fire suppressing material into the protected space.

26. The method according to claim 18, wherein the storage vessel comprises a bladder tank.

27. The method according to claim 18, wherein the membrane comprises an elastomeric diaphragm.

28. The method according to claim 18, wherein the step of discharging the fire suppressing material comprises at least partially vaporizing the liquid fire suppressing material as it is discharged from the at least one nozzle into the protected space.

29. The method according to claim 18, wherein the fire suppressing material comprises a clean agent.

30. The method according to claim 18, wherein the fire suppressing material comprises a fluorinated ketone.

31. The method according to claim 18, wherein the step of discharging the fire suppressing material from the at least one nozzle into the protected space comprises emitting the fire suppressing agent from the at least one nozzle at a noise level of less than 100 dB.
